(19) United States
(12) Patent Application Publication
(10) Pub. No.: US 2024/0303746 A1
(43) Pub. Date: Sep. 12, 2024

(54) DIGITAL SYSTEM AND PLATFORM PROVIDING A USER-SPECIFIC ADAPTABLE, FLEXIBLE DATA PROCESSING USING A COMBINATION OF A MARKOV CHAIN MODELLING STRUCTURES AND CONFIGURABLE ELEMENTS AS STATES AND/OR STATE TRANSITIONS SPECIFIC TO AN INDIVIDUAL, AND METHOD THEREOF

(71) Applicant: Swiss Reinsurance Company Ltd., Zürich (CH)

(72) Inventors: Alexander RAICH, Zürich (CH); Jörg AULICH, Zürich (CH); Lars TACKMANN, Zürich (CH)

(73) Assignee: Swiss Reinsurance Company Ltd., Zürich (CH)

(21) Appl. No.: 18/438,558

(22) Filed: Feb. 12, 2024

Related U.S. Application Data
(63) Continuation of application No. PCT/EP2023/069767, filed on Jul. 17, 2023.

(30) Foreign Application Priority Data
Jul. 19, 2022 (CH) 000854/2022

(51) Int. Cl. G06Q 40/08; G06Q 10/067

(52) U.S. Cl. CPC G06Q 40/08; G06Q 10/067

(57) ABSTRACT

Proposed is a digital, state discrete system and platform and corresponding method thereof, for automated underwriting and pricing of individually predicted loss covers using a combination of a Markov Chain modelling structure and configurable elements at least comprising states and/or state transitions and/or cashflows specific to the product it instantiates. The digital system comprises a simulation engine using deterministic transition and interest rates of a discrete process to conduct calculations per policy, wherein parts of the process are used with stochastic transition and interest rates of a discrete process for conducting simulations on portfolio level. The calculations take place on a slice level and are aggregated on benefit and quote level, wherein a slice is created whenever a policy benefit is subject to an unscheduled sum assured increase, and wherein for new business each benefit starts with one slice, each slice being related to the specific product version, cover, and tariff relevant at that the respective point in time the slice is created for.

### CROSS REFERENCE TO RELATED APPLICATIONS

The present application is a continuation application of International Patent Application No. PCT/EP2023/069767, filed Jul. 17, 2023, which is based upon and claims the benefits of priority to Swiss Application No. 000854/2022, filed Jul. 19, 2022. The entire contents of all of the above applications are incorporated herein by reference.

### FIELD OF THE INVENTION

The present invention relates to digital system and platforms flexible adaptable by a plurality of users providing automated user-specific adaptable, flexible data processing, inter alia applicable to automated pricing of risk-transfers for an individual policy. In particular, it relates to digital system relying on Markov Chain modelling structures capturing states and/or state transitions and/or cashflows specific to a risk-transfer relying on mortality or life measures.

### BACKGROUND OF THE INVENTION

In traditional life risk-transfer industry, a finite-state Markov chain is often used as technical structure to capture and parametrize, i.e. to represent different state of the insured during data processing. Associating monetary amount vales with sojourn times in states and transitions between states allows to generate and forecast a present value for life risk-transfer losses to be expected within an associated error margin at a set interest rate value. Traditionally these model structures have been used with deterministic interest rate parameter settings and deterministic transition rate parameter settings, however in recent life risk-transfer forecast modelling and simulations, stochastic modelling structures of the interest parameters and transition rate parameters has gained attention in automation and data processing. This is of particular technical interest either if the risk (herein understood as the technical value of the forecasted frequency and aggregated event strength (actually occurring event loss) within a future measuring time window) associated with changes in the underlying interest parametrization and transition rate parameters is to be captured and forecasted, and/or if one wants to hedge this forecasted risk by building up balancing securities based on these same underlying rate parameter settings. A technical life risk-transfer setup with stochastic transition rate settings is, where the underlying rate parameters are processed and captured by a finite-state Markov chain model structure and, in particular, dependence between the rate parameters is enabled within the structure. In the prior art systems, there are various technical data processing treatment of stochastic interest rates applied in life risk-transfer modelling and for forecasting stochastic mortality rate parameter values. Also combined model structures for stochastic interest and mortality rate parameters settings are known. Common to several of the prior art systems is that interest and mortality rate parameters are technically propagated and thus modelled by engineering model structures representing affine model processes for the data processing. This class of processes leads to technically tractable modelling and forecasts, where the core of the data processing is reduced to solve a system of ordinary differential equations instead of partial differential equations in order to find expected present values, which is of great technical advantage for data processing by finite state machines being based on finite state processors. The present invention technically allows for the application of affine processes in more general life risk-transfer modelling structures, thus making it easier and technically more efficient to forecast by data propagation and simulation expected present values.

It is known in the prior art systems, that finite-state Markov chain structures can be applied for data propagation in modelling risk-transfer and appropriate pricing parameters for a specific risk-transfer but can also be applied for forecasting of credit risks. Credit risk is defined herein as the actual and/or expected degree of value fluctuations in debt instruments and derivative structures due to measured changes in the underlying credit quality of associated counterparties or counter units. While vector autoregression (VaR) model structure applied to daily market risk calculations is able to generate about 250 forecast in one year, credit risk model structures technically are limited to about one forecast per year due to their tail structure. Thus, it would take a very long time to produce sufficient observation measurements for reasonable tests and weighting of forecast accuracy for these data processing structures. In addition, due to the nature of credit risk measurements, only a limited amount of historical data on credit losses can be assessed which is not enough to span several macroeconomic or credit cycle processing. These data limitations create a serious technical difficulty for the validation and calibration of credit risk model structures. It is to be mentioned that vector autoregression model structures are statistical based structures used to capture and propagate the relationship between multiple quantities and measures as they change over time. Thus, all VAR structures are types of stochastic process modelling. VAR modelling technically generalize the single-variable (univariate) autoregressive modelling by allowing for capturing multivariate time series. Similar to the autoregressive model structures, each measured or captured variable has a relation (function or equation) modelling and propagating its evolution over time. This relation includes the variable's lagged(past) values, the lagged values of the other variables in the model structure, and an error term. VAR model structures have the advantage that they do not require as much information about the forces influencing a variable as do structural model structures based on simultaneous equations. The only information, technically required, is an appropriate filter for variables which can be hypothesized to affect each other over time.

Thus, a major technical impediment to model validation (so called “back testing”), not only for life-risk-transfer modelling but also for credit risks modelling, is the small number of forecasts available with which to calibrate a model's forecast processing accuracy. There is a need to provide a more flexible modelling and simulation structure which can be used to forecast and propagate the relevant parameter values reliably to a future time range. Also basic credit risk model structures can typically be captured by a two-state Markov chain, where a jump from the initial state represents a default. An extension of this model, known in the prior art, is to let the default transition rate be modelled as a stochastic process itself such that it is possible for it to be dependent on the interest rate and other economic factors. This approach can be applied to various Markov chain model structures. In a more general treatment of the Marchkov chain approach to credit risk modelling with stochastic transition rates it can be shown how prices generally satisfy a system of partial differential equations. In both approaches, it can be shown how one can benefit from affine stochastic processes as transition intensities and economic measuring factors. If the modelling structure is particularly simple, the Riccati relation can be used to reduce the modelling problem of solving a system of partial differential equations to that of solving a system of ordinary differential equations, which can have significant technical advantages in terms of data processing efficiency and used time. The technical approach of the present invention has, inter alia, the advantage, that it allows to generalize these prior art methods allowing for risk-transfer pricing in more general decrement Markov chain model structures. Therefore, while Markov Chain modelling structures are used widely in risk-transfer technology and industries, its combination with configuration elements according to the present invention allows a level of flexibility and dynamism. The present inventive system can, inter alia, be applied for doubly stochastic Markov chain structures, in particular in life risk-transfer and credit risk forecast and simulations. It can further be applied for the generation of transition probabilities in certain doubly stochastic Markov chains, wherein the resulting output-signaling can e.g. be used for valuation of life insurance contracts.

The prior art document US 2012/0296676 A1 discloses a system for processing disparate data for generating an insurability decision. An extract, transform, load (ETL) process extracts the data and converts it into a standard format. A heuristic engine processes the converted data to identify information relevant to the decision to be rendered. A consolidation engine generates knowledge from the relevant information and presents the knowledge to a decision-making entity for rendering the decision. An optimization feedback process monitors actions on the knowledge by the decision-making entity and adjusts the ETL process, the heuristic engine, and the consolidation engine as a function of the monitored actions. Further, the prior art document U.S. Pat. No. 10,572,945 B1 discloses a system for automated estimation of insurance loss ratios, claims frequencies, probabilities of excess claims, and insurance policy performance characteristics for an individual insured or for groups of insured individuals. A time-series-derived Bayesian power spectrum weight is generated based on the frequency of temporal pattern-specific values in terms of intensities at various frequencies of the power spectrum computed from credit utilization ratio (CUR) time-series obtained by the insurer by ‘soft pull’ inquiries submitted periodically to credit-rating agencies, and provides capturing and measuring of the relative magnitude of frequent or unexpected changes in consumer liquidity. The present technology provides a sys-tem and method for classifying insurance risk, for insurance risk scoring, or for incorporating a power-spectrum-based temporal pattern-specific weight into an actuarial method to enhance the loss ratio estimation accuracy and statistical financial performance of insurance products and health plans. KR1 02222928 B1 discloses a system for financial estimations. The system determines a financial estimate target fund based on the user identification information and receives base data corresponding to the financial estimation target fund. The system extracts at least one principal component from relevant variables included in the base data using a macroscopic financial estimation model, predicts the relevant variables in consideration of population characteristics using a micro-financial estimation model, and derives a financial estimate using the extracted principal component and the predicted relevant variables. Finally, CN 108053326 A discloses system for cost performance orderings of life insurance products. The system determines the transfer probability among different insurance responsibility states of each insurance product according to an incidence rate table of the insurance industry, and a Markov state transfer matrix is established. The system determines, based on clauses of the insurance state, a cash flow matrix along the Markov state transfer matrix during state transfer. The net insurance premium of the insurance product is obtained by utilizing an actuarial pricing principle on the basis of the Markov state transfer matrix and the cash flow matrix and according to an earning rate curve of the product. Cost performances of insurance products are ordered according to the ratio of the net insurance premium to the practical sales price of each insurance products.

### SUMMARY OF THE INVENTION

It is an object of the invention to provide more efficient and more accurate and more flexible systems and methods allowing newly dynamic and automated propagation of life risk parameters and associated automated dynamic risk-transfer pricing and dynamic premiums generation and assessment for a policy capturing the individual risk-transfer settings and parameter values. It is further an object of the present invention to allow for using a combination of Markov Chain modelling structures and configurable elements (States, State transitions, Cashflows) specific to a risk-transfer, it instantiates, which was not possible by the prior art systems.

According to the present invention, these objects are achieved particularly through the features of the independent claims. In addition, further advantageous embodiments follow from the dependent claims and the description.

According to the present invention, the abovementioned objects are particularly achieved by the digital system, automated platform and automated method in that for life risk parameter propagation and for dynamic and automated risk-transfer pricing by processing a plurality of individual risk-related parameters associated with a portfolio of risk-transfers of risk-exposed individuals, wherein each risk-transfer held associated with the portfolio is set by risk-transfer parameters of a risk-transfer policy defining the individual risk-transfer, wherein a combination of a Markov Chain modelling structure with configurable elements are applied at least comprising states and/or state transitions and/or cash-flows specific to the risk-transfer, and wherein a stochastic Markov data processing is applied to the Markov chain structure over a sequence of possible events in which the probability value of each event depends only on the state attained in the previous event, in that the digital system comprises a calculation engine comprising a data structure for capturing and/or storing deterministic transition and interest rate parameter values of a state discrete process to conduct data processing per policy, wherein parts of the process are used with stochastic transition and interest rates of a discrete process for conducting simulations on portfolio level, in that the digital system comprises an interface to the Markov chain structure, wherein for the stochastic Markov data processing, interest parameter values and transition rate parameter values are user-specific and flexible configurable and/or selectable from an associated digital library, and wherein within the stochastic Markov data processing setup and stochastic transition rates, these underlying rates are processed and modelled by the finite-state Markov chain structure, and in that for the data processing by the finite-state Markov chain structure, one or more transition functions are configurable via the data interface and/or selectable from the digital library, the transition functions linking at least two states within the Markov chain structure wherein all states of the Markov chain structure are linked to a antecedent and a successive state providing the data processing over the whole configurable Markov chain structure.

The technical approach of the present invention has, inter alia, the advantage, that it allows to generalize the above discussed prior art methods allowing for risk-transfer pricing in more general decrement Markov chain model structures. Therefore, while Markov Chain modelling structures are used widely in risk-transfer technology and industries, its combination with configuration elements according to the present invention allows a level of flexibility and dynamism. The present inventive system can, inter alia, be applied for doubly stochastic Markov chains, in particular in life risk-transfer and credit risk modelling. It can further be applied for the generation of transition probabilities in certain doubly stochastic Markov chains, wherein the resulting output-signaling can e.g. be used for valuation of life insurance contracts.

### BRIEF DESCRIPTION OF THE DRAWINGS

The present invention will be explained in more detail below relying on examples and with reference to these drawings in which:

FIG. 1 shows a block diagram illustrating schematically exemplary the relationships between the configuration and the calculation, as well as the hierarchy of the configurable elements themselves.

FIGS. 2 to 4 show block diagrams illustrating schematically an exemplary overview of slices with FIG. 2 showing the color legend and FIG. 3 the according slice processing.

FIG. 5 shows a block diagram illustrating schematically an exemplary state-transition-cashflow-modelling structure and/or 3 state-transition-cashflow-modelling structure.

FIGS. 6 to 7 show block diagrams illustrating schematically an exemplary overview of how the Markov Chain modelling structure is used, where FIG. 6 shows a simple Markov Chain modelling example, and FIG. 7 a simple Markov Chain calculation for premium cashflow linked to state A. FIGS. 6 and 7 shows an example of a Markov calculation of the present value for 1 contract. If the example is applied to 1000 customers, then: 1st year, 100*1000=100,000 are received. If in 2nd year 20% are deceased, then the active customers are 800 and 90*800=72,000 are received (instead of 90*1000=90,000).

FIG. 8 shows block diagrams illustrating schematically exemplary logical architecture of the inventive digital system/platform and method.

FIG. 9 shows a block diagram illustrating schematically the data model entities which are used by the calculation service providable by the digital platform apart from the inventive data processing and forecast: (i) Holding all risk-transfer and pricing parameters, (ii) The configuration elements used by the calculation engine to automatically generate quotes, premiums, or refunds parameter values for customers, (iii) Flexible configuration of cashflows attached to states and state transitions, which's based on stochastic processes. However, implementing it in practice for risk-transfer purposes is not known as well as its embedding in the context of the proposed wider solution, (iv) Configuration-based calculations—a feature that allows key calculations to be configured rather than hard-coded, e.g. ‘sum-date-years’, (v) Benefit slices—To allow maximum flexibility as user needs change, every instance of a policy is made up of multiple benefit slices . . . the Calc service can calculate on a per slice basis, ensuring accurate and auditable automated pricing parameters generation and outputs.

FIG. 10 shows block diagrams illustrating schematically exemplary technical integration structure and pattern for associating 3rd party systems.

FIG. 11 shows block diagrams illustrating schematically exemplary calculation framework and product framework. The calculation framework comprises (A) the calculation components of (1) Calculation requests are sets of data, which refer to a particular process, product and policy (unless the calculation request is about creating a policy), (2) Calculation rules are sets of rules for calculating values of attributes and attribute properties, and (3) Calculation responses are sets of data, which represent a particular policy; and (B) the calculation entities of (1) Calculation entities are sets of attributes and their attribute properties, which are subject to certain calculation rules. The diagram on the right-hand side shows calculation-relevant entity relationships from different domains. Further the product framework defines the full set of allowable configuration options on product/benefit/tariff level, of which subsets can be used by products: (A) The product entity framework defines the full set of allowable configuration options on product level, of which subsets can be used by products. Example: The initial product framework might allow for Premium frequency yearly and monthly and might be enhanced over time to also allow for half-yearly and quarterly. (B) The benefit entity framework defines the full set of allowable configuration options on benefit level, of which subsets can be used by benefits. Example: The initial benefit framework might allow for Cover type “level” and might be enhanced over time to also allow for “decreasing”, and (C) The tariff entity framework defines the full set of allowable configuration options on tariff level, of which subsets can be used by tariffs. Example: The initial tariff framework might allow for Decreasing frequency yearly for the sum assured decreasing sum assured and might be enhanced over time to also allow for monthly. In general calculation-relevant attributes will be located on tariff level to enhance flexibility to allow for different values per policy slice. Example: Premium rate tables are located on tariff level in order to have the ability to always apply the latest Premium rate tables per policy slice.

FIGS. 12a to 12c show block diagrams illustrating schematically the sequence of steps how a policy with the benefits and the benefits with the slices are being generated. FIGS. 12a to 12c support the understanding of the description of a process, given by: (A) In order to achieve extensibility (ease of change and extension) and decoupling of the configuration of the calculation from its execution: (i) All calculation elements are, or can be expressed, as a function that receives as argument the current quote period and returns a decimal number. See separate pdf for the full list of functions. (ii) The returned ‘BigDecimal’ allows to represent any kind of number: double, float, integer . . . . So internally all operations will be done using ‘BigDecimal’ . . . & all defined as a ConfigurationAttribute will be resolved to a CalculationElement. (iii) Example ‘special’ functions: Present Value; Sum Assured config; (B) The output is a collection of trees of calculation elements: (i) Any output element can be expressed as the composition of some basic calculation elements and its dependent calculation elements. A calculation element can be seen as the root of a tree of all the dependencies it needs to return a decimal number. The leaf nodes of that tree will be always an INPUT or PARAMETER or any other independent calculation element, (ii) ConfigurationAttribute and relationship with CalculationElement, (iii) All ConfigurationAttribute will define a Function<CoverPeriod, BigDecimal>, (iv) Input: The CalculatorInput interface defines the input for our Calculator. We have opted for an implementation of a Typesafe heterogenous container. (v) Output: The CalculatorOutput interface defines the output of our Calculator—to be flexible enough for any kind of Quote model, the output is a mere dictionary of names associated to Collection<BigDecimal>. (vi) Validation is also a function: CalculationElement Validator: The CalculationElementValidator interface it is also a function, but in this case is a Predicate<CoverPeriod, BigDecimal>. Two implementations are provided, but there is not implementation for the parsing from ConfigurationAttribute to simplify the PoC (the implementation of them could be easily added in the CalculationFactory because Calculation offers them in its API).

FIG. 13 shows block diagrams illustrating schematically an exemplary calculation and generation process, respectively. They support the understanding of the description of a process, given by (note that not all in this description is part of the diagram): (i) After all CalculationElement are created from their Configuration. getAllAttributes( ) counterparts, the created Calculation is passed to the Calculator. (ii) Quote calculation’ included in above diagram. (iii) Slice management/built quote is also covered in FIG. 13. In addition, the digital system can e.g. comprise (a) Stream parallelization in Calculator, (b) Returning already built CalculationElement in CalculationFactory+More implementations of CalculationElement, (c) coverTerm Years . . . , not having to calculate all the elements again (d) Enhance calculation request configuration flexibility by atomizing the calculation request into micro calculation requests on quote, benefit and slice level, which are pre-processed and run in dynamic order, so that MTAs can be defined exclusively by pre-processing rules (and all of them use the same core-processing rules): (i) pre-processing i.e. creating the micro calc requests on quote, benefit and slice level and populate them, (ii) core-processing, i.e. executing the micro calc requests by using the core calculation, which always stays the same.

FIG. 14 shows block diagrams illustrating schematically an exemplary technical accounting (TA) structure by a process flow diagram of the solution (note that not all in this description is part of the diagram). The goal of the technical accounting domain is to provide source accounting data in order to support ledger systems (LFD). The solution allows an event-based policy admin system to integrate with traditional RDBMS (Relational DataBase Management Systems) LFD platforms. Further it allows to provide outputs policy-level accounting data via both DLE & Control Report, allowing data to be cross-checked directly with the source system.

FIG. 15 shows block diagrams illustrating schematically an exemplary technical accounting (TA) structure (note that not all in this description is part of the diagram). The embodiment variant uses (i) DDD (Domain Driven Design), (ii) CQRS (Command Query Responsibility Segregation) (iii) ES (Event Sourcing). It aggregates with ES: (a) Accounting Plan (b) Remittances, (c) Arrears. It aggregates without ES: (a) Quote. ES+CQRS is implemented with a lightweight framework. ES Events are internal, and are NOT events in Kafka topics, but events in an internal event store. Only belongs to the Technical Accounting service. The system uses Hexagonal architecture, the project can be split into modules by concerns. The Domain only knows about the interface of the persistent store but has no idea about the underlying storage/implementation.

FIG. 16 shows block diagrams illustrating schematically an exemplary policy lifecycle processes (note that not all in this description is part of the diagram). The policy structure and service hold policy-related data and drives the policy lifecycle, listening to all other services and making sense of the policy/customer at any given point in time. It includes the third party service (i.e. customer/company data and their roles against individual policies). The embodiment variant e.g., comprises (i) The definable rules, behaviour and interaction of the ‘Product/Calc’ and ‘Policy’ services, as well as the operations and validations required to get take a policy into force, plus the associated benefits and riders—all of which is driven by configuration, (ii) Benefit slices—To allow maximum flexibility as customers' needs change, every instance of a policy is made up of multiple benefit slices. While slices exist in other systems, the inventive use and interact with them across the system to generate policy changes (Mid Term Adjustments) is not known in the prior art.

FIG. 17 shows block diagrams illustrating schematically an exemplary policy structure. Design principles of the refactored policy structure and service design can e.g. comprise (i) Isolate application and domain logic, (ii) Domain-driven-design, (iii) Improved REST API for policy management to follow the business processes, (iv) Evolving of the event schemas to simplify messaging.

FIG. 18 shows a block diagram illustrating schematically an exemplary digital system and platform 1 for mortality probability parameter value propagation 121 and for dynamic and automated impact-cover pricing 122 by processing a plurality of individual mortality-related measuring parameters 123 associated with a portfolio 124 of loss-covers 1241 of risk-exposed individuals 2. Each risk-transfer 1241 held associated with the portfolio 124 is set by risk-transfer parameters 12411 of a loss-covers 1241 as risk-transfer policy defining parameter-based the individual risk-transfer 1241, wherein a combination of a Markov Chain modelling structure 11 with configurable elements are applied at least comprising states 114 and/or state transitions 113 and/or cash-flows 112 specific to the risk-transfer 1241, and wherein a stochastic Markov data processing is applied to the Markov chain structure 11 over a sequence of possible events 25/25i in which the probability value of each event 25/25i depends only on the state 114 attained in the previous event 25.

FIG. 19 shows a block diagram illustrating schematically the triggering of an automated digital twin structure adaption steered by output signal 143 generated by digital individual measuring engine 3 based on measured parameter values of wearables/IoT sensory 15, and on the other side the feedback of monitored and/or detected by thresholding of the digital twin parameters to the simulation engine 12 and/or the Markov Chain structure 11.

### DETAILED DESCRIPTION OF THE PREFERRED EMBODIMENTS

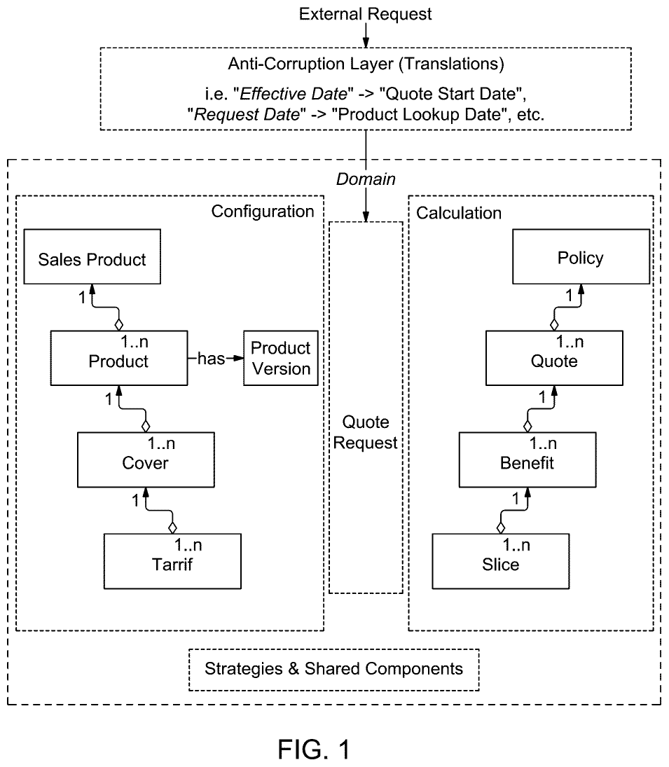

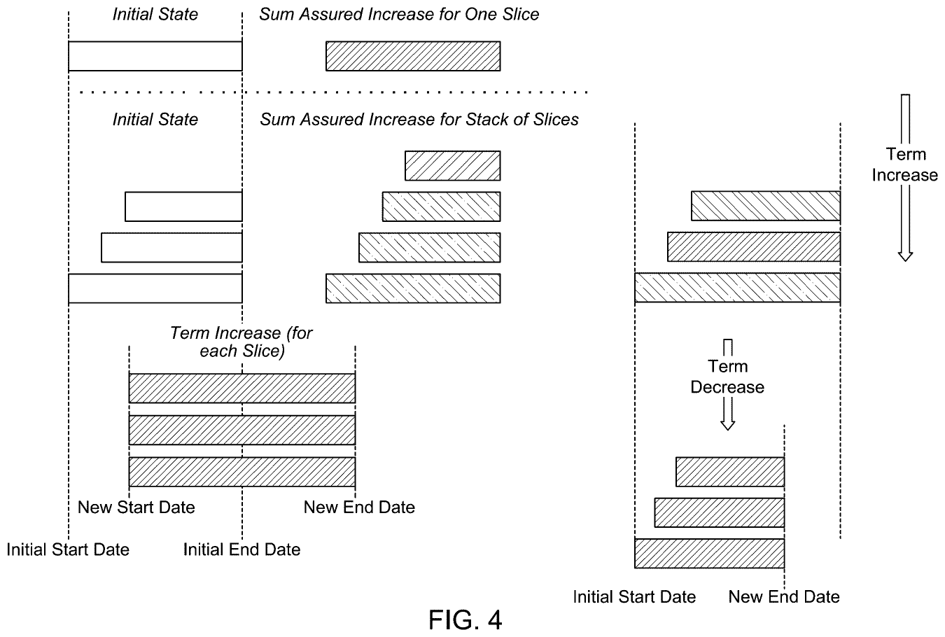

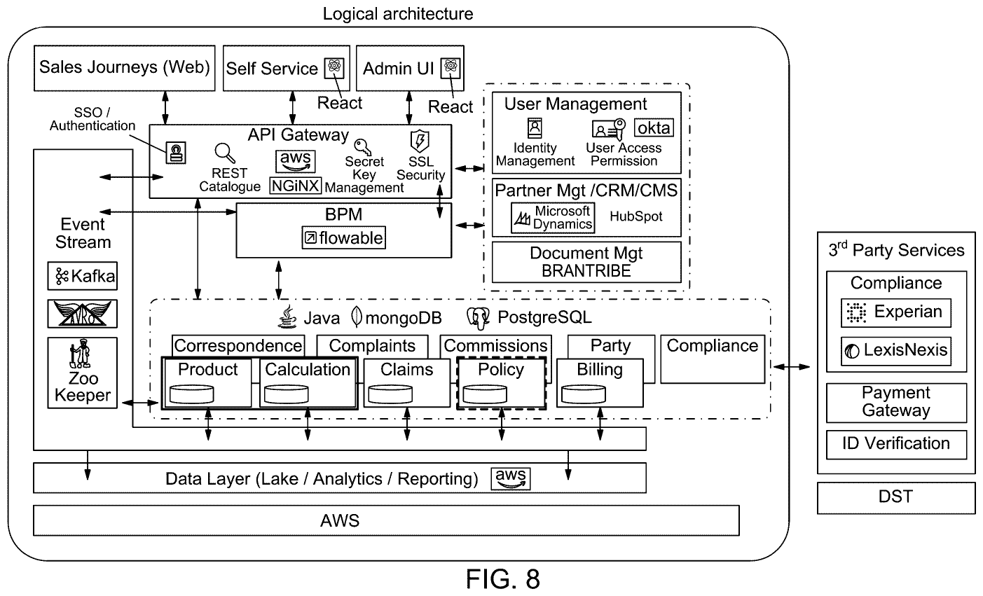

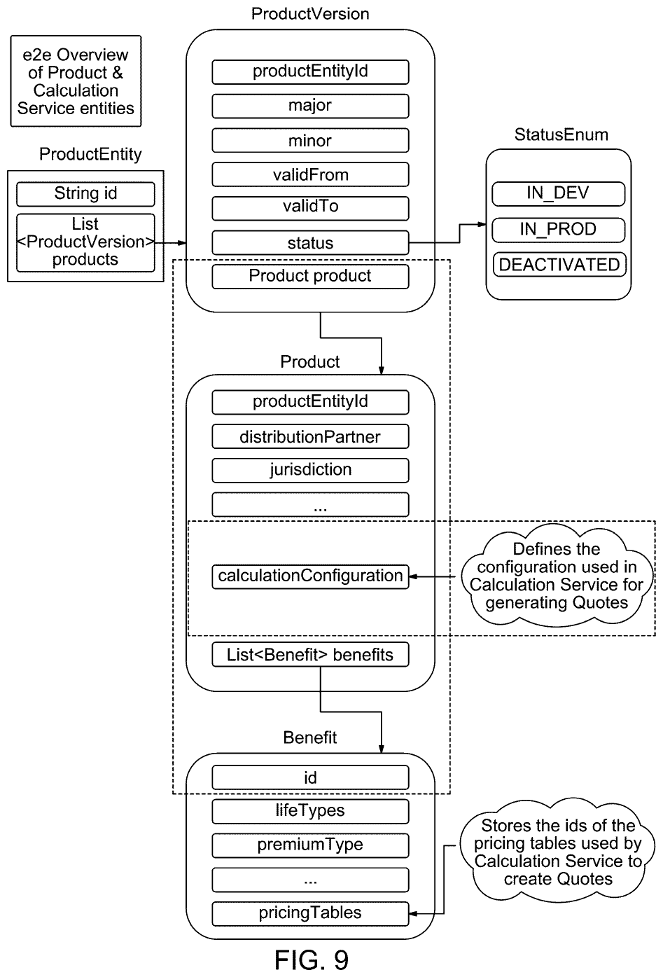

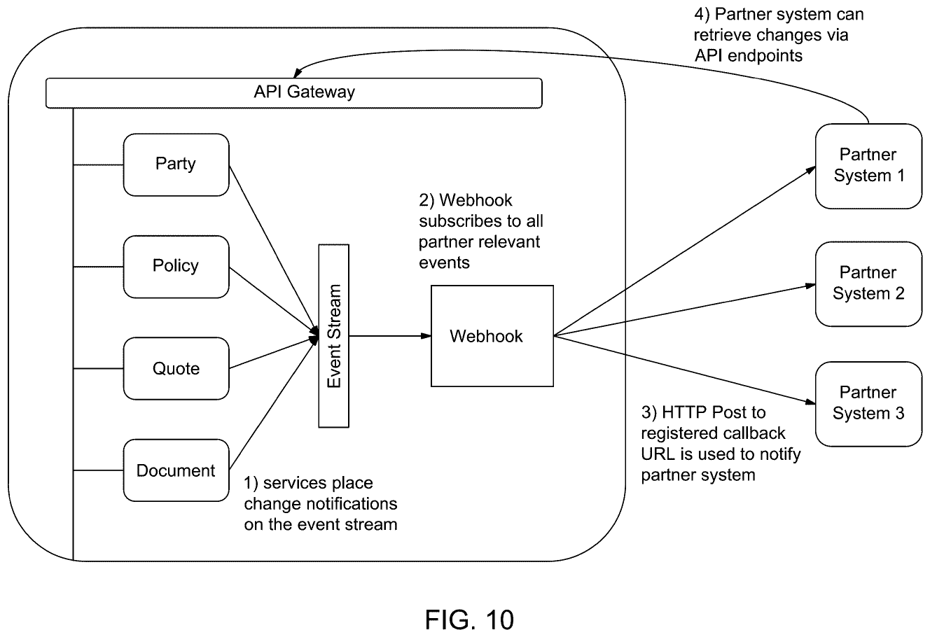

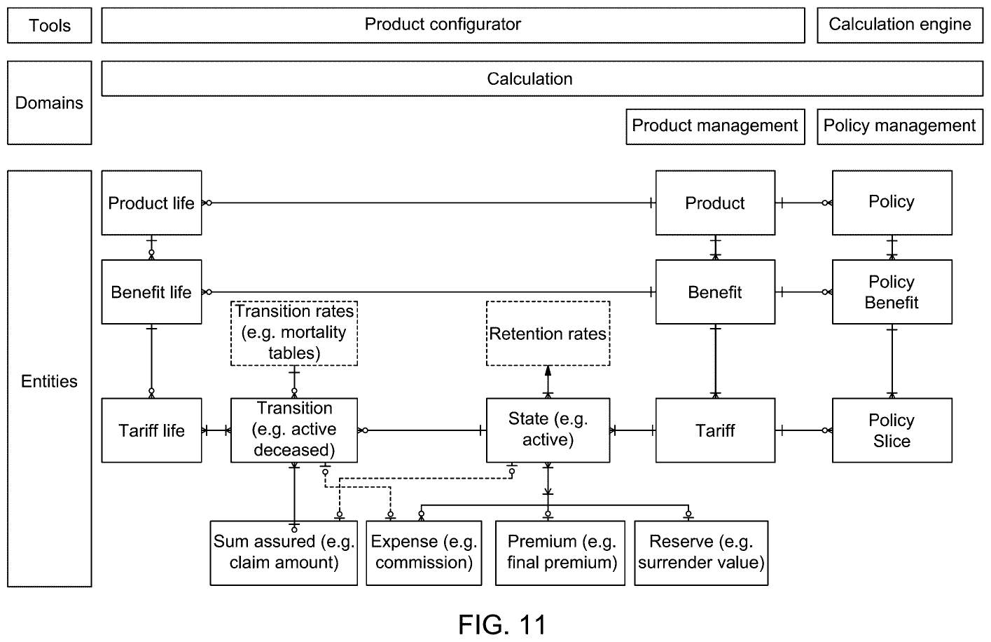

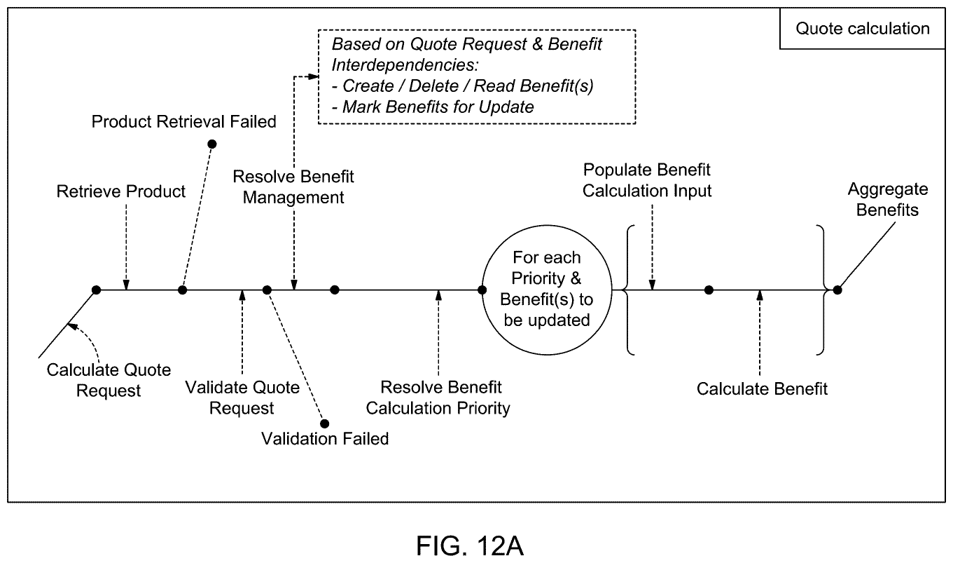

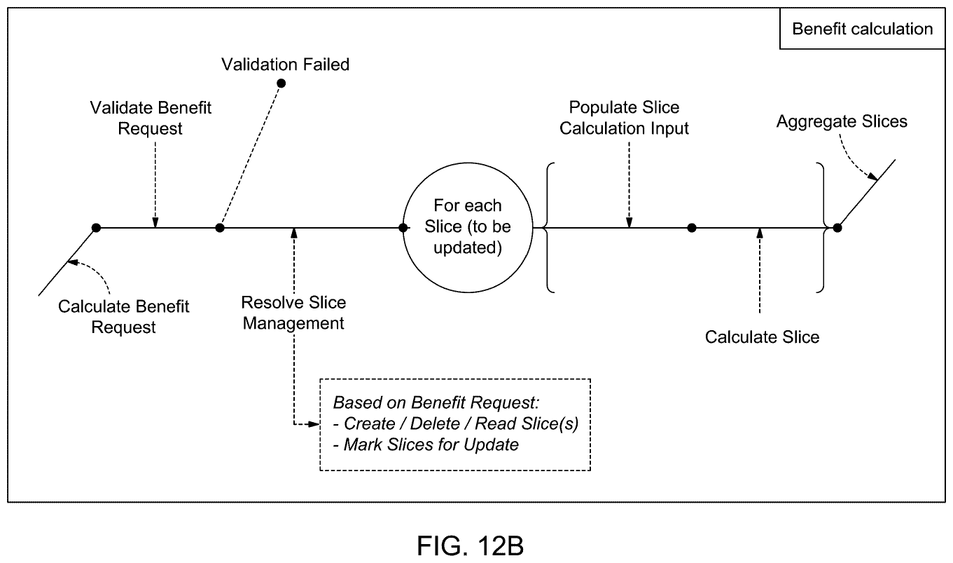

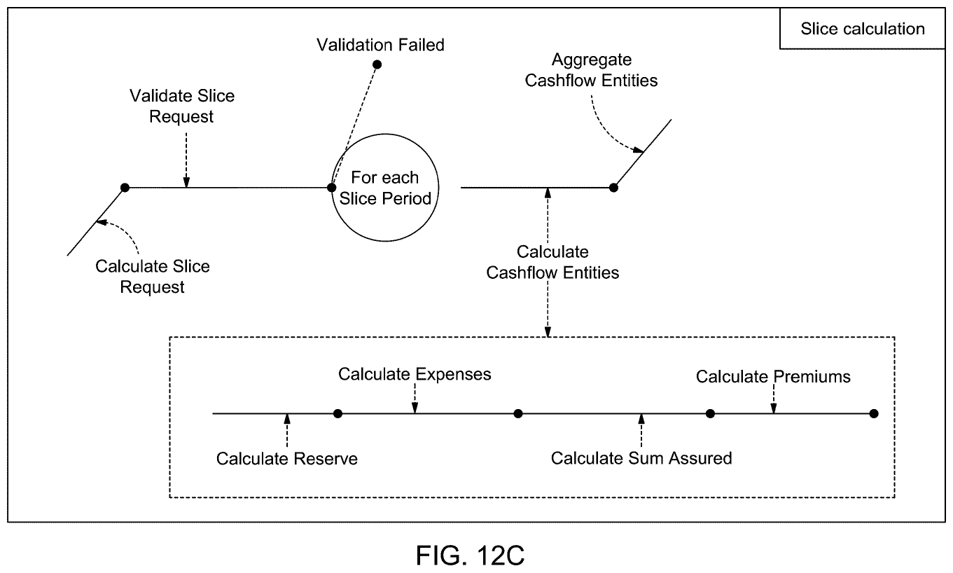

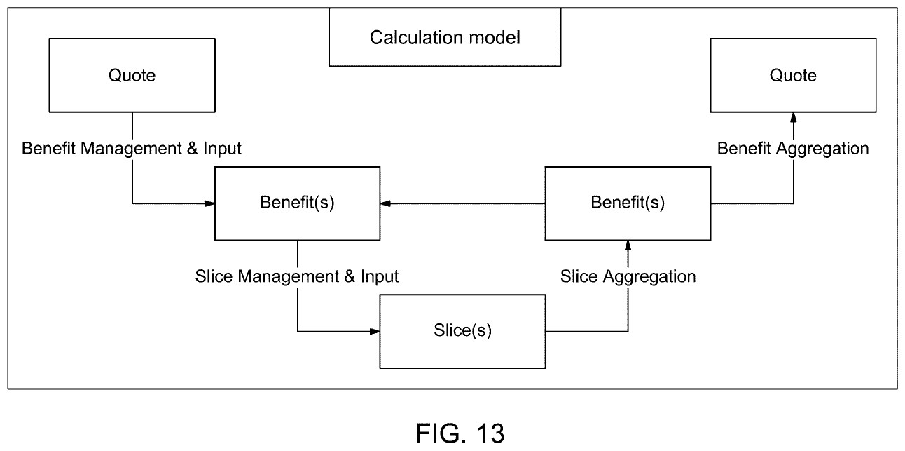

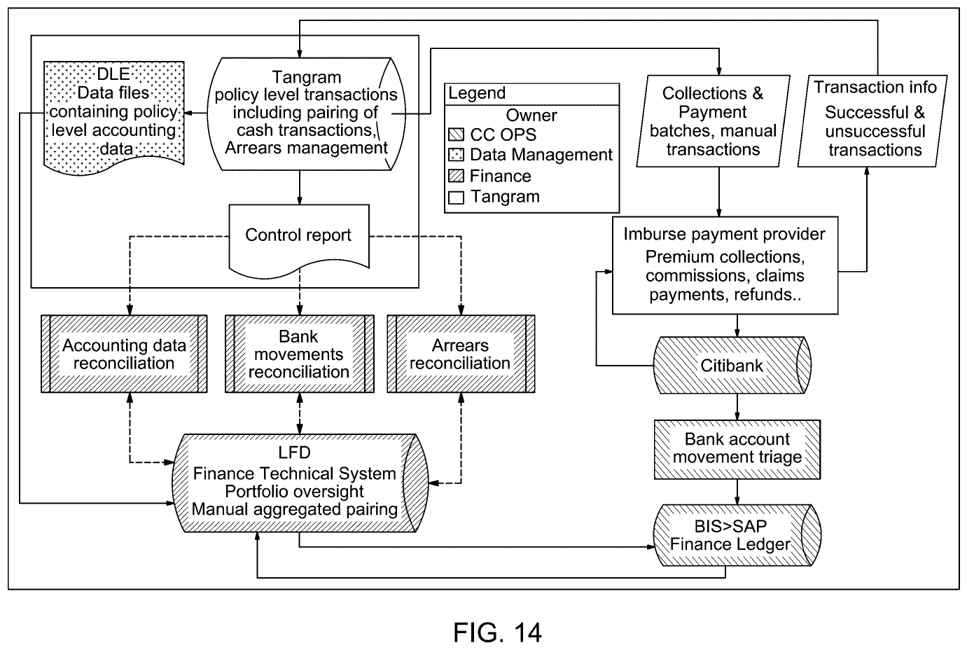

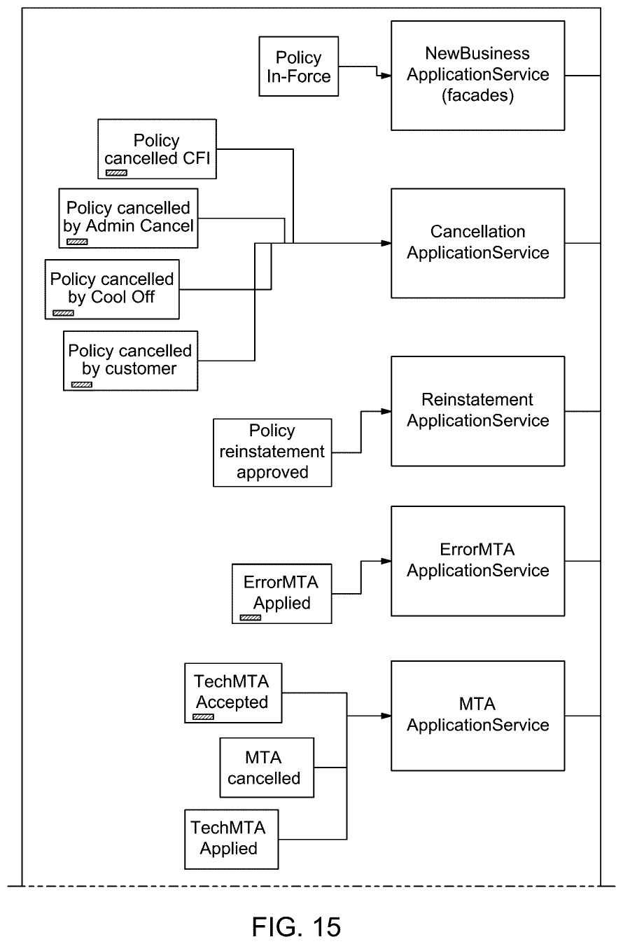

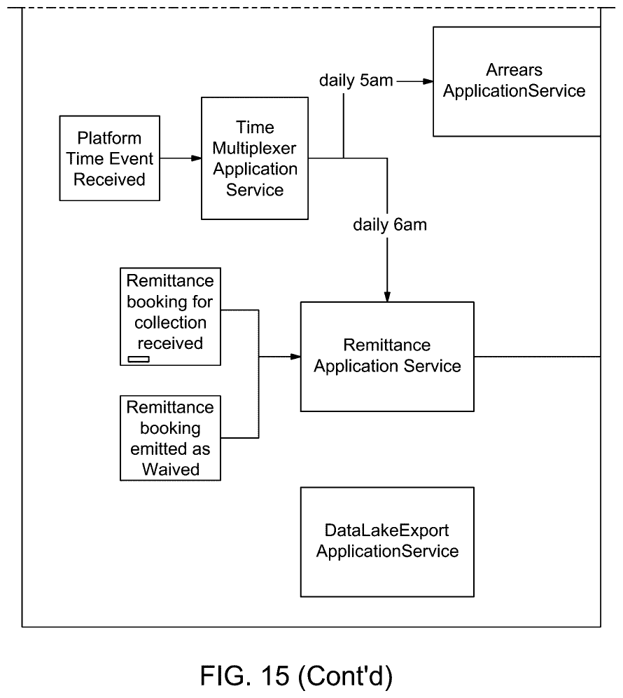

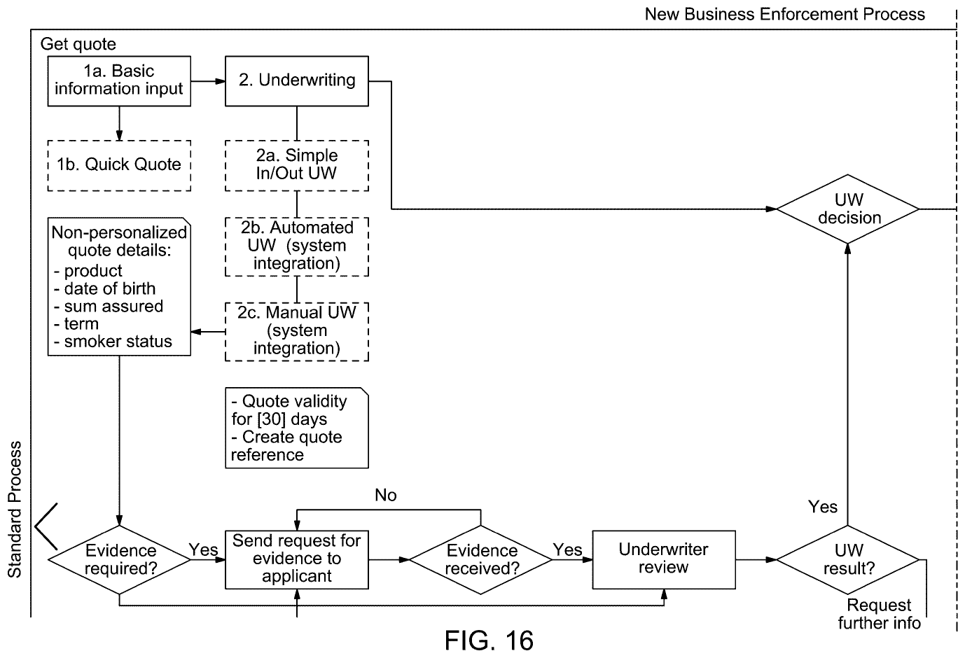

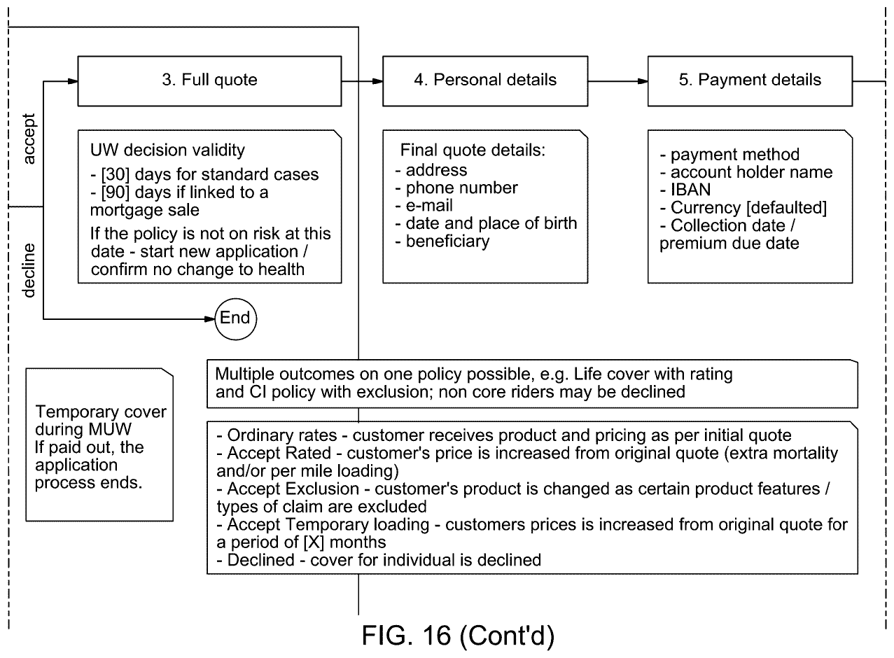

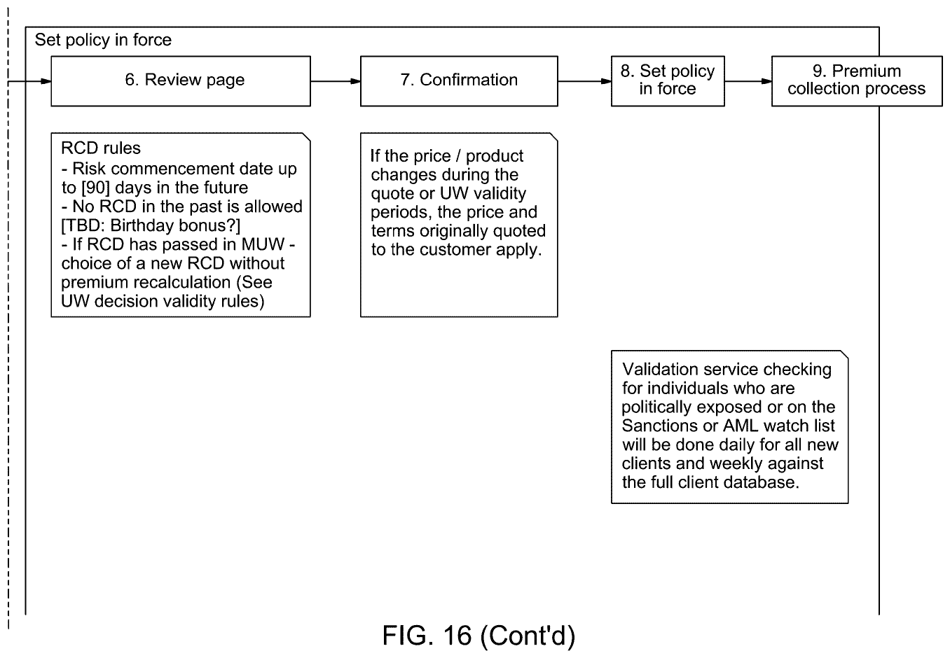

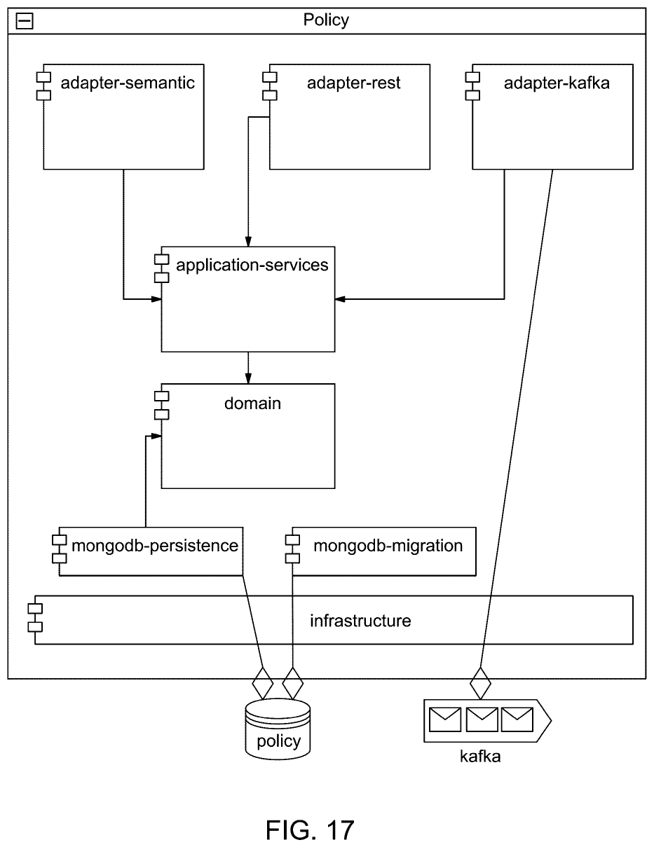

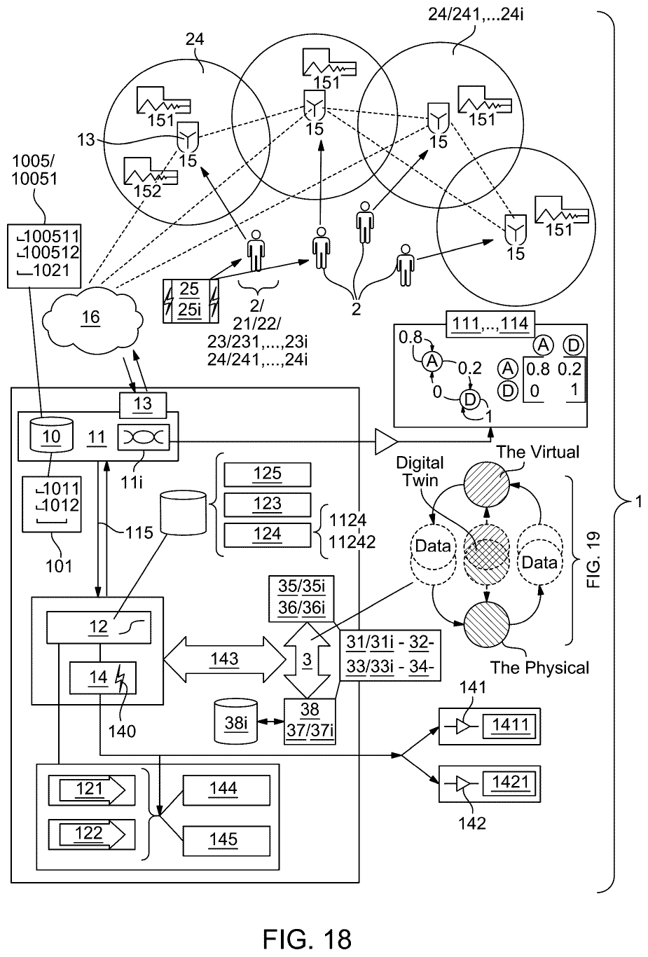

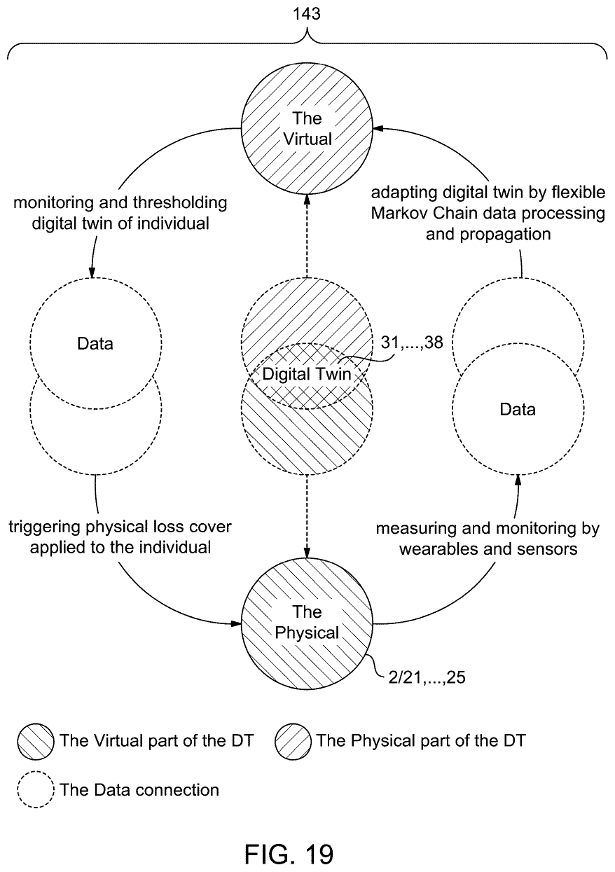

FIGS. 1-17 schematically illustrate an architecture for a possible implementation of an embodiment of the inventive digital platform and digital system 1 for mortality probability measuring parameter value propagation, i.e. measured life risk parameter propagation, and for dynamic and automated risk-transfer pricing by processing a plurality of individual risk-related parameters associated with a portfolio of risk-transfers of risk-exposed individuals. The pricing is dynamically performed and also the dynamic generation of the risk-transfer premiums for an individual policy using a combination of a Markov Chain modelling structure and configurable elements at least comprising states and/or state transitions and/or cash-flows specific to the product it instantiates. Each risk-transfer held associated with the portfolio is set by risk-transfer parameters of a risk-transfer policy defining the individual risk-transfer. A combination of a Markov Chain modelling structure with configurable elements are applied at least comprising states and/or state transitions and/or cash-flows specific to the risk-transfer. A stochastic Markov data processing is applied to the Markov chain structure over a sequence of possible events in which the probability value of each event depends only on the state attained in the previous event.

The digital system comprises a calculation engine using deterministic transition and interest rates of a discrete process to conduct calculations per policy, wherein parts of the process are used with stochastic transition and interest rates of a discrete process for conducting simulations on portfolio level. In particular, the calculation engine comprises a data structure for capturing and/or storing deterministic transition and interest rate parameter values of a state discrete process to conduct data processing per policy, wherein parts of the process are used with stochastic transition and interest rates of a discrete process for conducting simulations on portfolio level,

The digital system comprises a user interface to the Markov chain structure, wherein for the stochastic Markov data processing, interest parameter values and transition rate parameter values are user-specific and flexible configurable and/or selectable from an associated digital library, and wherein within the stochastic Markov data processing setup and stochastic transition rates, these underlying rates are processed and modelled by the finite-state Markov chain structure. The digital library can e.g. be accessible by a plurality of users, wherein the transition functions and/or the interest parameter values and/or the transition rate parameter values of a user are accessible by another user via the data interface and applicable to the other user's finite-state Markov chain structure. The transition functions and/or the interest parameter values and/or the transition rate parameter values of a first user can e.g. only be accessible upon request of a second user and/or upon approval or enablement by the first user to the second user.

For the data processing by the finite-state Markov chain structure, one or more transition functions are configurable via the data interface and/or selectable from the digital library, the transition functions linking at least two states within the Markov chain structure wherein all states of the Markov chain structure are linked to an antecedent and a successive state providing the data processing over the whole configurable Markov chain structure.

As an embodiment variant, dependences between the rate parameters can e.g. be applicable within the finite-state Markov chain structure. The finite-state Markov chain structure can e.g. further comprise elements providing flexible configuration for the use of combined model structures for stochastic interest parameter values and/or mortality rate parameter values. The stochastic Markov data processing of the interest parameters and mortality rate parameters can be configured by affine data process structures, wherein the finite-state Markov chain structure becoming a traceable model structure during propagation of the parameter values to a defined future time window. For the flexible configuration, the digital system can e.g. comprise adaptable calculation configuration files and/or trees processable by the calculation engine of the digital system. The Markov chain structure can e.g. be realized as a continuous time Markov chain structure with a finite or countable infinite state space providing a stochastic process for parameter propagation. Further, the Markov chain structure can e.g. be provided by the digital system only for time-homogeneous Markov chain processes, where all probability values providing a measure for a life risk within a future time window are generated based on the Markov property.

The system can e.g. comprise a slice generator, wherein data processing is sliced by taking place on a slice level and aggregated on a state of benefit and quote level, wherein a slice is created whenever a policy benefit is subject to an unscheduled sum assured increase, and wherein for each newly applied risk-transfer each benefit starts with one slice, each slice being related to the specific risk-transfer version, cover and tariff at that a respective point in time, the slice is generated for. As such, the calculations can e.g. take place on a slice level and are aggregated on benefit and quote level, wherein a slice is created whenever a policy benefit is subject to an unscheduled sum assured increase, and wherein for new business each benefit starts with one slice, each slice being related to the specific product version, cover, and tariff relevant at that the respective point in time the slice is created for.

The present invention allows insurance premiums to be generated and assessed dynamically for an individual policy, using a combination of the established Markov Chain model and configurable elements (States, State transitions, Cashflows) specific to the product it instantiates. The system comprises a calculation engine using deterministic transition and interest rates of a discrete process to conduct calculations per policy. The system can e.g. also use parts of this with stochastic transition and interest rates of a discrete process can thus support conducting simulations on portfolio level.

The inventive data processing and/or calculations take place on slice level and are aggregated on benefit and quote level (as shown in FIG. 1). A slice is created whenever a policy benefit is subject to an unscheduled sum assured increase, i.e. for new business each benefit starts with one slice. Each slice relates to the specific product version, i.e. risk-transfer structure version, cover and tariff that is relevant at that the respective point in time, the slice is created for. While Markov Chain modelling structures are used widely in automated insurance and risk-transfer technology and other industries, its combination with configuration elements allows a level of flexibility and dynamism that is novel and not known in the prior art.

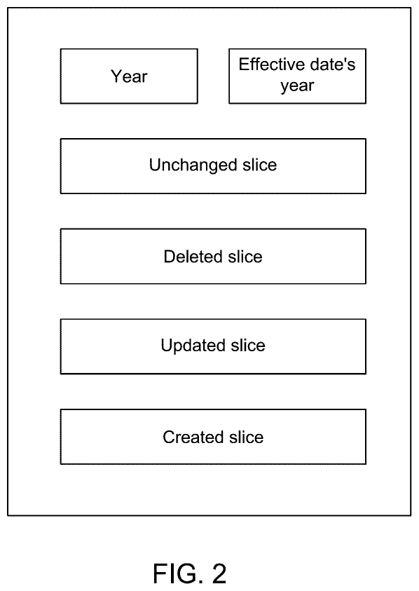

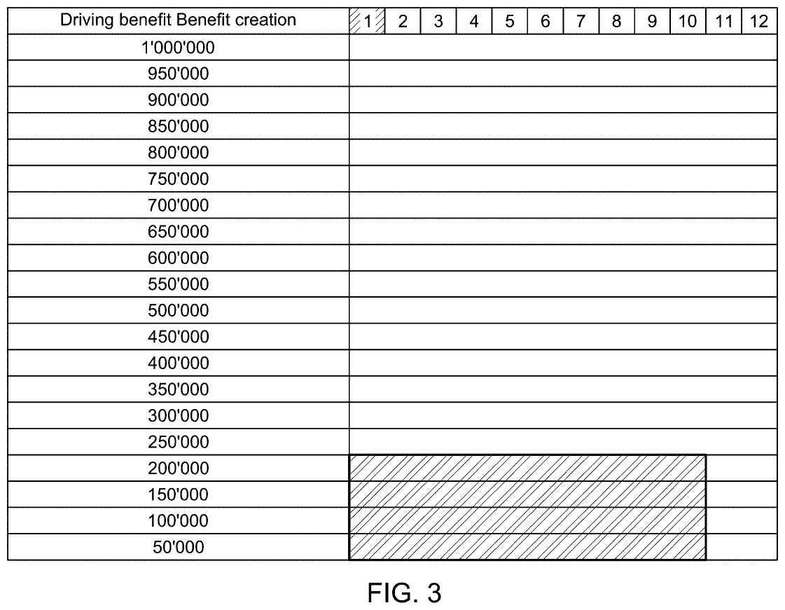

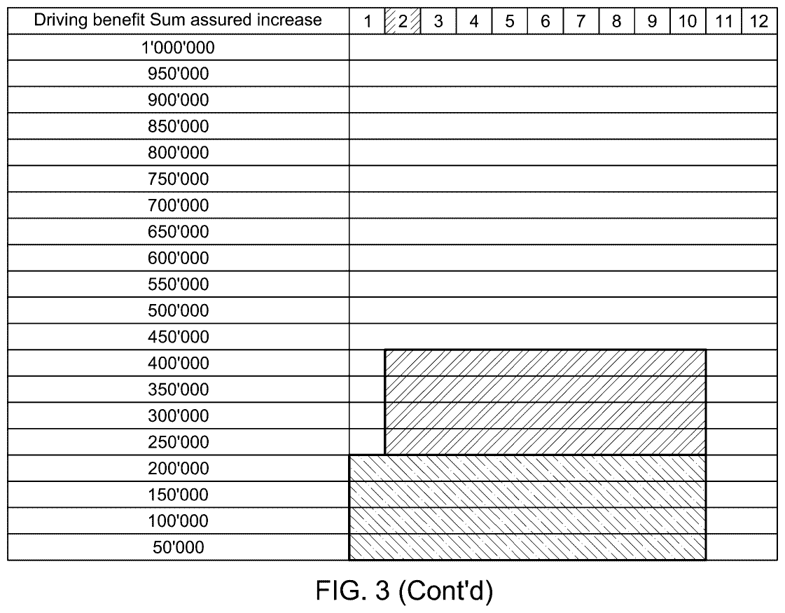

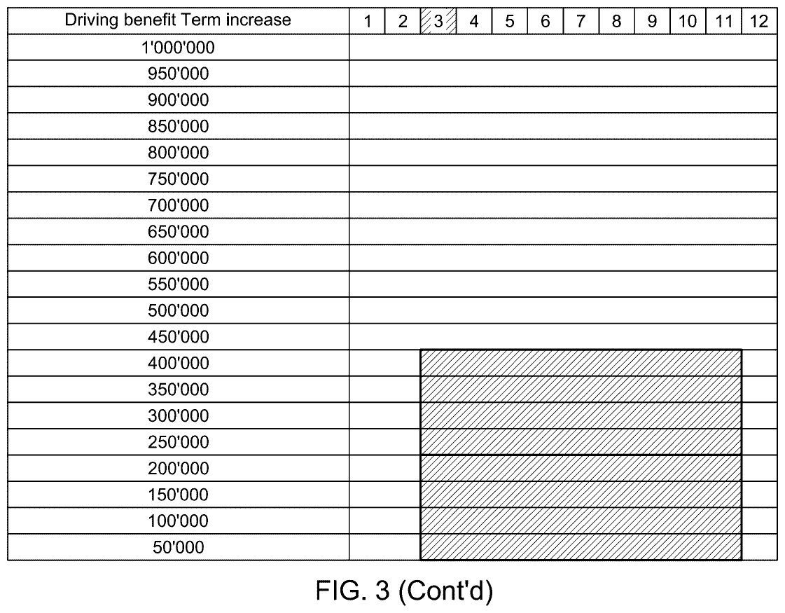

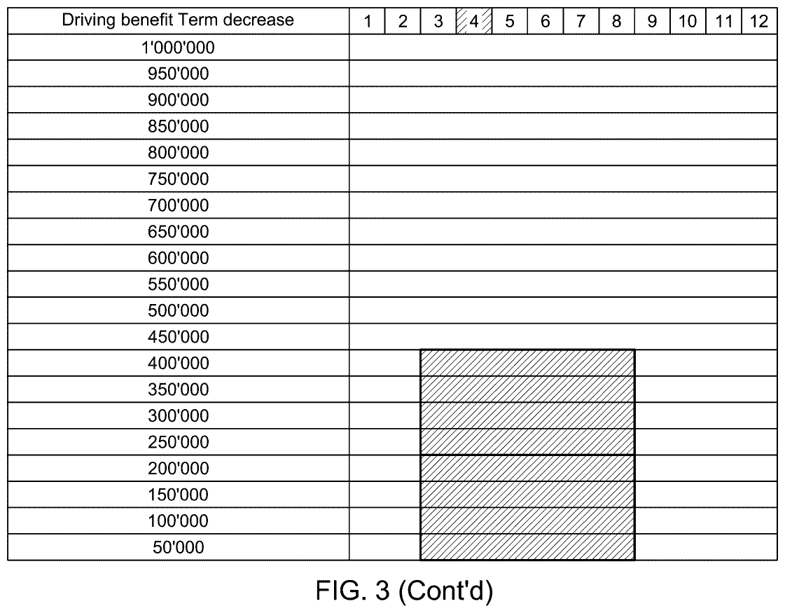

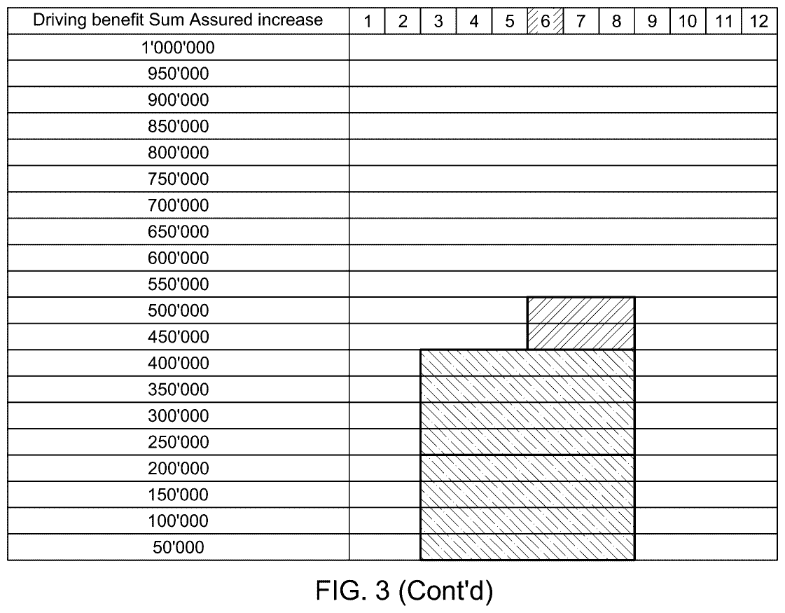

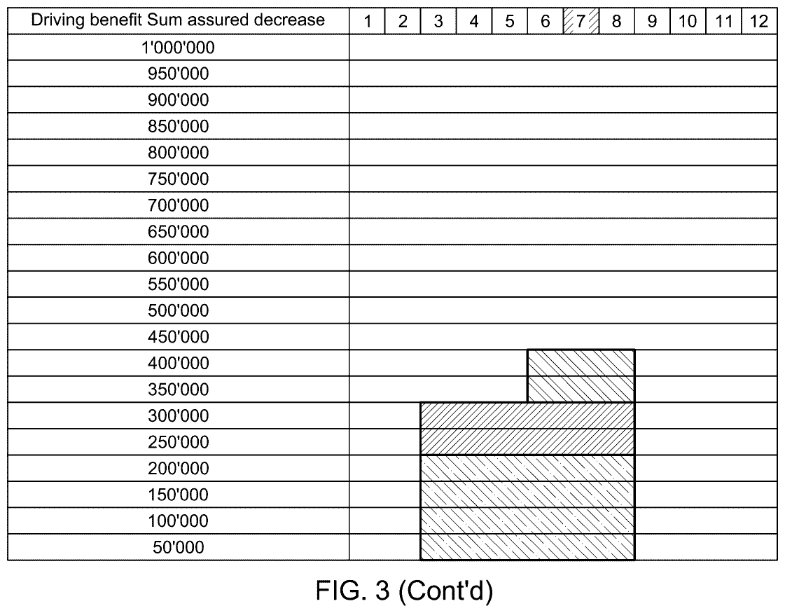

FIGS. 2 to 4 show block diagrams illustrating schematically an exemplary overview of slices with FIG. 2 showing the color legend and FIG. 3 the according slice processing.

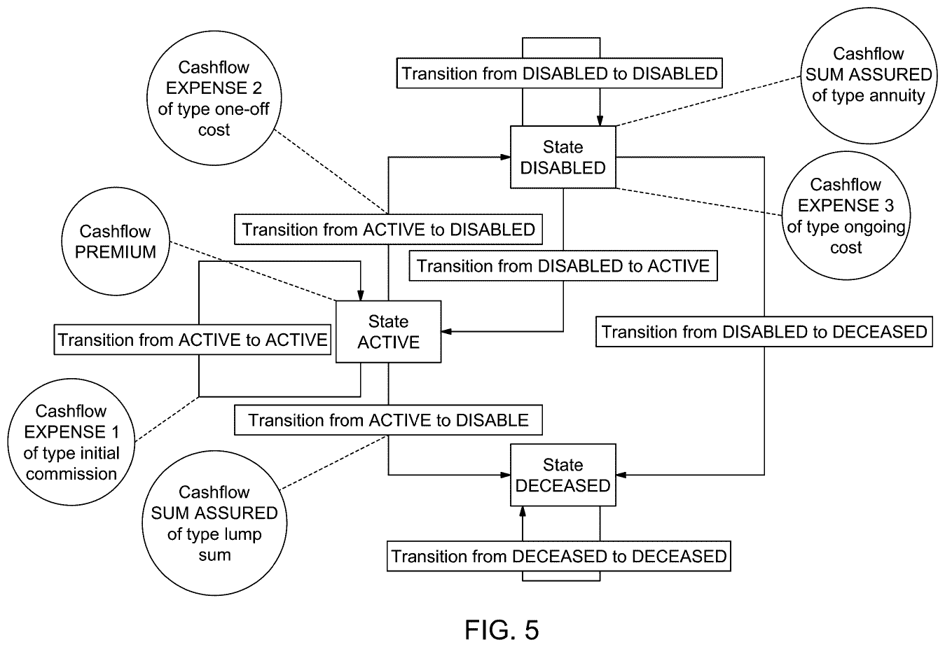

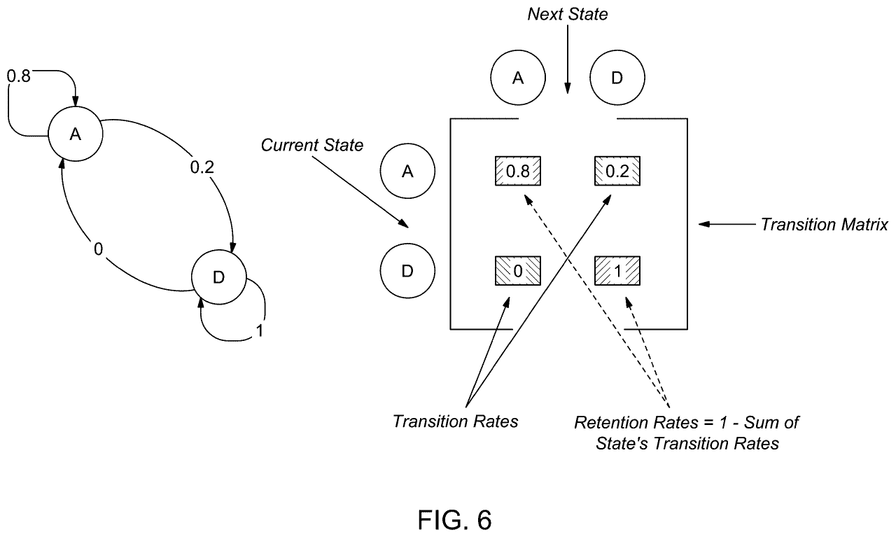

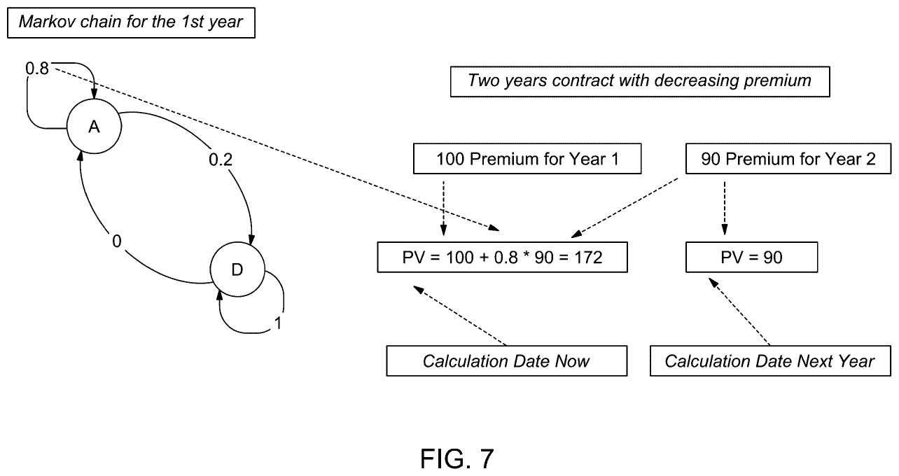

The present invention also technically allows to model cashflows and link them to states or state transitions according to the respective tariff—this allows to generate and/or calculate the cashflows' present value at each discrete point in time. This dynamic is visualized in FIG. 5. FIG. 5 shows a block diagram illustrating schematically an exemplary state-transition-cashflow-modelling structure and/or 3 state-transition-cashflow-modelling structure. FIGS. 6 to 7 show block diagrams illustrating schematically an exemplary overview of how the Markov Chain modelling structure is used, where FIG. 6 shows a simple Markov Chain modelling example, and FIG. 7 a simple Markov Chain calculation for premium cashflow linked to state A. FIGS. 6 and 7 shows an example of a Markov calculation of the present value for 1 contract. If the example is applied to 1000 customers, then: 1st year, 100*1000=100,000 are received. If in 2nd year 20% are deceased, then the active customers are 800 and 90*800=72,000 are received (instead of 90*1000=90,000).

A mathematical representation of the present value formula for a (sub-)set of modelled cashflows on slice level is as follows:
PVₜ^{S} (CF) . . . Present value of a set CF of cashflow amount vectors for state S at calculation period t

Cₜ^{S} . . . Cash flow amount for state S at calculation period t
vₜ^{k} . . . Discount rate at time t for the time from calculation period t to calculation period t+k
qₜ^{S→T} . . . Transition rate for state S to state T at calculation period t
Cₜ^{S→T} . . . Cashflow amount for state S to state T at calculation period t

$${PV}_{t}^{S} ( CF ) = {\sum }_{C ∈ CF} {C}_{t}^{S} + {v}_{t}^{1} * \{ {\sum }_{T} [ {q}_{t}^{S \to T} * ( {\sum }_{C ∈ CF} {C}_{t}^{S \to T} + {PV}_{t + 1}^{T} ( CF ) ) ] \}$$

It is to be noted that the implementation of the calculation engine can e.g. use deterministic transition and interest rates of a discrete process to conduct calculations on policy level. However, the present invention can also be realized using parts of this with stochastic support conducting the simulation processing on portfolio level.

### LIST OF REFERENCE SIGNS

1 Digital Platform and System
   10 Data Store
      101 Data Structure
         1011 Modular Digital Transition Functions
         1012 Marchkov Chain Data Elements
   11 Marchkov Chain Modelling Structure/Predictor/Simulator
      111 Applied Transition Functions
      112 Applied Interest Parameter Values
      113 Applied Transition Rate Parameter Values
      114 Markov Chain States
      115 Output parameter values of the flexible Markov Chain Structure
   12 Simulation engine for automated process/Stochastic Markov data processing
      121 Probability parameter value propagation process
      122 Automated pricing process
      123 Individual mortality-related measuring parameters based on measuring parameters associated with individual 2/2i/2ii
      124 Data structure container/Portfolio
         1241 Data structures capturing loss-cover/risk-transfer parameters of a risk-transfer (Policy/Risk-Transfer)
         12411 Risk-transfer parameters
      125 Digital library
   13 Data transfer interface
   14 Output signal generator
      140 Electronic output signaling
      141 Trigger signal triggering automated underwriting process
         1411 Automated electronic underwriting system
      142 Steering and thresholding signal for automated portfolio management and management adaption
         1421 Automated digital portfolio management system electronically steered by the signaling of the Markov Chain Predictor 11
      143 Triggered automated digital twin adaption steered by output signal generated by digital individual measuring engine 3 based on measured parameter values of wearables/IoT sensory 15
      144 Digital actionable offers
      145 Automatedly generated new digital risk-transfer policies
   15 Wearables/IoT Sensory (input devices and sensors)
      151 Bodily sensory devices
      152 Environmental sensory devices
   16 Data transmission network
2 Real-world Risk-exposed Individual
   21 Physical Body Structure
   22 Intangible Body Conditions (Psychological)
   23 Subsystems of the Real-world Individual
      231, 232, 233, . . . , 23i Subsystems 1, . . . , i
   24 Environment/Ecosystem of Individual
      241, 242, 243, . . . , 24i Subsystems 1, . . . , i
   25 Physical real-world event impacting physically individual by causing a measurable physical damage/body injury or loss to the individual
      251 Illness
      252 Accident
      253 Natural catastrophe (earthquake/storm/hurricane/flood etc.)
3 Digital Individual Measuring Engine
   31 Digital Intelligence Layer
      311 Machine Learning
      312 Neural Network
   32 Body Parameters of the Real-World Individual
   33 Status Parameters of Real-World Individual
      331 Physiological (Body) Status Parameters
      332 Psychological Status Parameters
      333 Habits/Behavioral Status Parameters (Nutrition/Sport etc.)
      333 Environmental Status Parameters (Living Condition etc.)
   34 Data Structures Representing States of Each of the Plurality of Subsystems of the Real-World Individual
   35 Digital Peril and/or Life-risk-event Robot
      351 Simulation
      352 Synchronization
      353 Twin Linking: Sensory/Measuring/Data Acquisition-Wearables/IoT Sensory 15
   36 Digital Ecosystem Replica Layer
      361, 362, 363, . . . , 36i Virtual Subsystems of Virtual Representation of Ecosystem
   37 Digital Object/Element Layer of the Individual
      371 Simulation
      372 Synchronization
      373 Linking: Sensory/Measuring/Data Acquisition-Wearables/IoT Sensory 15
   38 Digital Individual Replica Layer
      381, 382, 383, . . . , 38i Virtual Subsystems of Real-World Individual

1. A digital system and platform for mortality probability parameter value propagation and for dynamic and automated impact-cover pricing by processing a plurality of individual mortality-related measuring parameters associated with a portfolio of loss-covers of risk-exposed individuals, wherein each loss-cover held associated with the portfolio is set by risk-transfer parameters of a loss-covers as risk-transfer policy defining parameter-based the individual risk-transfer, wherein a combination of a Markov Chain modelling structure with configurable elements are applied at least comprising states and/or state transitions and/or cash-flows specific to the risk-transfer, and wherein a stochastic Markov data processing is applied to the Markov chain structure over a sequence of possible events in which the probability value of each event depends only on the state attained in the previous event, the digital system comprising:
a simulation engine comprising a data structure for capturing and/or storing deterministic transition and interest rate parameter values of a state discrete process to conduct data processing per policy, wherein parts of the process are used with stochastic transition and interest rates of a discrete process for conducting simulations on portfolio level, and
an interface to the Markov chain structure, wherein for the stochastic Markov data processing, interest parameter values and transition rate parameter values are user-specific and flexible configurable and/or user-specific selectable from an associated digital library, and wherein within the stochastic Markov data processing setup and stochastic transition rates, these underlying rates are processed and modelled by the finite-state Markov chain structure,
wherein the stochastic Markov data processing of the interest parameters and mortality rate parameters is configured by affine data process structures, wherein the finite-state Markov Chain Structure becoming a traceable model structure during propagation of the parameter values to a defined future time window, wherein for the flexible configuration, the digital system comprises adaptable calculation configuration files and trees processable by the simulation engine, and
the data processing by the finite-state Markov chain structure, one or more transition functions are configurable via the data interface and/or selectable from the digital library, the transition functions linking at least two states within the Markov chain structure wherein all states of the Markov chain structure are linked to an antecedent and a successive state providing the data processing over the whole configurable Markov chain structure.

2. The digital system and platform according to claim 1, wherein the digital system and platform comprises a signal generator automatically generating an electronic signaling based on the output parameter values of the electronic Markov Chain structure, the electronic signally being transferred to an automated underwriting system of the digital system triggering at least one automated underwriting process by assigning automatically at least one risk-exposed individual processed by the Markov Chain structure to a risk-transfer associated with a future occurrence of physical event physically impacting the at least one risk-exposed individual.

3. The digital system and platform according to one of the claim 1, wherein the digital system and platform comprises a signal generator automatically generating an electronic signaling based on the output parameter values of the electronic Markov Chain structure, the electronic signally being transferred to an automated digital portfolio management system of the digital system automatically adapting threshold values for at least one risk-exposed individual processed by the Markov Chain structure, the at least one risk-exposed individual being automatically assigned to the portfolio, where an occurring loss and/or damage and/or injury of an individual associated with a future occurrence of physical event physically impacting the at least one risk-exposed individual is automatically covered by the system.

4. The digital system and platform according to claim 1, wherein dependences between the flexible configurable transition and interest rate parameters are applicable within the finite-state Markov Chain Structure.

5. The digital system and platform according to claim 1, wherein the finite-state Markov Chain Structure further comprises elements providing flexible configuration for the use of combined model structures for stochastic interest parameter values and/or mortality rate parameter values.

6. The digital system and platform according to claim 1, wherein the Markov chain structure is realized as a continuous time Markov Chain Structure with a finite or countable infinite state space providing a stochastic process for parameter propagation.

7. The digital system and platform according to claim 1, wherein the Markov chain structure is provided only for time-homogeneous Markov chain processes, where all probability values providing a measure for a life risk within a future time window are generated based on the Markov property.

8. The digital system and platform according to claim 1, wherein the system comprises a slice generator, wherein data processing is sliced by taking place on a slice level and aggregated on a state of benefit and quote level, wherein a slice is created whenever a policy benefit is subject to an unscheduled sum assured increase, and wherein for each newly applied risk-transfer each benefit starts with one slice, each slice being related to the specific risk-transfer version, cover and tariff at that a respective point in time, the slice is generated for.

9. The digital system and platform according to claim 1, wherein the digital library is accessible by a plurality of users, wherein the transition functions and/or the interest parameter values and/or the transition rate parameter values of a user are accessible by another user via the data interface and applicable to the other user's finite-state Markov chain structure.

10. The digital system and platform according to claim 9, wherein the transition functions and/or the interest parameter values and/or the transition rate parameter values of a first user are only accessible upon request of a second user and/or upon approval or enablement by the first user to the second user.

11. The digital system and platform according to claim 1, wherein the digital system and platform further comprises a digital individual measuring engine updating and monitoring a digital twin structure comprising a digital intelligence layer, storable and adaptable body parameters of the real-world individual, storable and adaptable status parameters of real-world individual, adaptable data structures representing states of each of a plurality of subsystems, a digital peril and/or life-risk-event robot, a digital ecosystem replica layer, a digital object/element layer of the individual, and a digital individual replica layer.

12. The digital system and platform according to claim 11, wherein the signaling of the signal generator comprises electronic signaling to the digital individual measuring engine automatically triggering digital twin adaption steered by output signal generated by digital individual measuring engine based on measured parameter values of wearables/Internet of Things (IoT) sensory.

13. The digital system and platform according to claim 11, wherein the automated process of the simulation engine for processing the Markov Chain Modelling Structure or steering and operating the flexible adaptive Markov Chain predictor or simulator is at least partially based on continuously or periodically monitored and/or threshold-based detected parameter values of the digital twin structure comprising the digital intelligence layer, storable and adaptable body parameters of the real-world individual, the storable and adaptable status parameters of real-world individual, the adaptable data structures representing states of each of a plurality of subsystems, the digital peril and/or life-risk-event robot, the digital ecosystem replica layer, a digital object/element layer of the individual, and the digital individual replica layer.

14. A method implemented by a digital system and platform for mortality probability parameter value propagation and for dynamic and automated impact-cover pricing by processing a plurality of individual mortality-related measuring parameters associated with a portfolio of loss-covers of risk-exposed individuals, wherein each loss-cover held associated with the portfolio is set by risk-transfer parameters of a loss-covers as risk-transfer policy defining parameter-based the individual risk-transfer, wherein a combination of a Markov Chain modelling structure with configurable elements are applied at least comprising states and/or state transitions and/or cash-flows specific to the risk-transfer, and wherein a stochastic Markov data processing is applied to the Markov chain structure over a sequence of possible events in which the probability value of each event depends only on the state attained in the previous event, the method comprising:
capturing and/or storing deterministic transition and interest rate parameter values of a state discrete process by a simulation engine of the digital system to conduct data processing per policy, wherein parts of the process are used with stochastic transition and interest rates of a discrete process for conducting simulations on portfolio level,
configuring user-specific and flexibly and/or selecting user-specific from an associated digital library interest parameter values and transition rate parameter values captured via an interface for Markov chain structure and the stochastic Markov data processing, wherein within the stochastic Markov data processing setup and stochastic transition rates, these underlying rates are processed and modelled by the finite-state Markov chain structure,
configuring by using affine data process structures the stochastic Markov data processing of the interest parameters and mortality rate parameters, wherein the finite-state Markov Chain Structure becoming a traceable model structure during propagation of the parameter values to a defined future time window, wherein for the flexible configuration, the digital system comprises adaptable calculation configuration files and trees processable by the simulation engine, and
configuring, for the data processing by the finite-state Markov chain structure, one or more transition functions via the data interface and/or selecting those from the digital library, the transition functions linking at least two states within the Markov chain structure wherein all states of the Markov chain structure are linked to an antecedent and a successive state providing the data processing over the whole configurable Markov chain structure.

15. The digital method according to claim 14, wherein-one or more dependences between the rate parameters are applied within the finite-state Markov Chain Structure.

16. The digital method according to claim 14, wherein the finite-state Markov Chain Structure further comprises elements providing flexible configuration for the use of combined model structures for stochastic interest parameter values and/or mortality rate parameter values.

17. The digital method according to claim 14, wherein the stochastic Markov data processing of the interest parameters and mortality rate parameters is configured by affine data process structures, wherein the finite-state Markov Chain Structure becoming a traceable model structure during propagation of the parameter values to a defined future time window.

18. The digital method according to claim 14, wherein the digital system is flexible configured by adaptable calculation configuration files and/or trees processable by the simulation engine of the digital system.

19. The digital method according to claim 14, wherein the Markov chain structure is realized as a continuous time Markov chain structure with a finite or countable infinite state space providing a stochastic process for parameter propagation.

20. The digital method according to claim 14, wherein the Markov chain structure is provided only for time-homogeneous Markov chain processes, where all probability values providing a measure for a life risk within a future time window are generated based on the Markov property.

21. The digital method according to claim 14, wherein data processing by the Markov chain structure is sliced by a slice generator by taking place on a slice level and aggregated on a state of benefit and quote level, wherein a slice is created whenever a policy benefit is subject to an unscheduled sum assured increase, and wherein for each newly applied risk-transfer each benefit starts with one slice, each slice being related to the specific risk-transfer version, cover and tariff at that a respective point in time, the slice is generated for.

22. The digital method according to claim 14, wherein the digital library is accessed by a plurality of users, wherein the transition functions and/or the interest parameter values and/or the transition rate parameter values of a user are accessible by another user via the data interface and applicable to the other user's finite-state Markov Chain Structure.

23. The digital method according to claim 22, wherein the transition functions and/or the interest parameter values and/or the transition rate parameter values of a first user are only accessible upon request of a second user and/or upon approval or enablement by the first user to the second user.
